(19) United States
(12) Patent Application Publication
(10) Pub. No.: US 2006/0284833 A1
(43) Pub. Date: Dec. 21, 2006

(54) PORTABLE ELECTRONIC DEVICE CAPABLE OF PERFORMING A FUNCTION ACCORDING TO A SENSING RESULT OF PRESSURE

(76) Inventors: Chi-Hsiung Lin, Taipei Hsien (TW); Hsiang-Ti Hsu, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/164,175

(22) Filed: Nov. 14, 2005

(30) Foreign Application Priority Data
Jun. 15, 2005 (CN) 200510077938.4

(51) Int. Cl. G09G 5/00

(52) U.S. Cl. 345/156

(57) ABSTRACT

A portable electronic device includes a housing and a pressure sensor installed on the housing for sensing pressure applied to the portable electronic device. The portable electronic device further includes a logic unit for controlling operation of the portable electronic device according to a sensing result of the pressure sensor.

### BACKGROUND OF THE INVENTION

1. Field of the Invention

The present invention relates to a portable electronic device capable of performing a function according to a sensing result of pressure applied on the portable electronic device, and more particularly, to a portable electronic device capable of parking a magnetic head of a hard disk when a pressure sensor does not sense any pressure applied to the portable electronic device.

2. Description of the Prior Art

In modern information society, portable electronic devices are widely used in every field. Storage media of portable electronic devices are usually flash memory, such as SD cards, CF cards, and so on. The capacity of such storage media is not enough for developing technology, so there are more and more portable electronic devices with hard disks as storage media, such as the popular ipod manufactured by APPLE. However, it is easy to damage a hard disk by shocking a magnetic head of the hard disk, such as by dropping the hard disk, when the hard disk is reading or writing data so that stored data can be lost. Hence, it is important to prevent damage to a hard disk when a portable electronic device is dropped or socked while in use.

### SUMMARY OF THE INVENTION

It is therefore a primary objective of the claimed invention to provide a portable electronic device capable of parking a magnetic head of a hard disk when a pressure sensor does not sense any pressure applied to the portable electronic device for solving the above-mentioned problem.

According to the claimed invention, a portable electronic device includes a housing, a pressure sensor installed on the housing for sensing pressure applied to the portable electronic device, and a logic unit for controlling operation of the portable electronic device according to a sensing result of the pressure sensor.

According to the claimed invention, a method for controlling a portable electronic device according to a sensing result of pressure applied on the portable electronic device is disclosed. The method includes sensing whether pressure is applied to the portable electronic device, and controlling the portable electronic device to perform a function according to the sensing result of pressure applied to the portable electronic device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a portable electronic device according to the present invention.

FIG. 2 is a functional block diagram of the portable electronic device according to the present invention.

FIG. 3 is a flowchart of the portable electronic device performing a function according to a sensing result of pressure according to the present invention.

FIG. 4 is a diagram of the portable electronic device of FIG. 1 held by a user's hand.

FIG. 5 is a diagram of the portable electronic device of FIG. 1 positioned on a table.

FIG. 6 is a diagram of the portable electronic device of FIG. 1 falling.

### DETAILED DESCRIPTION

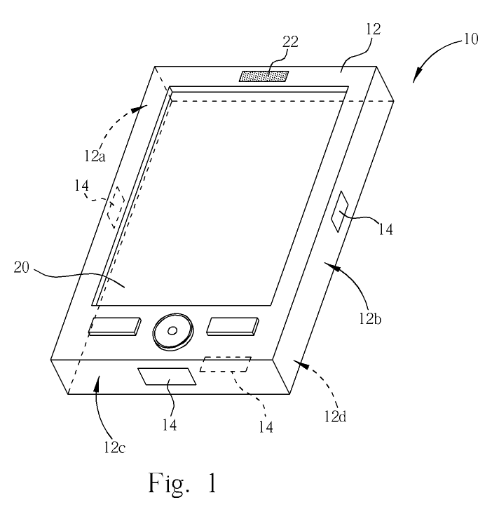

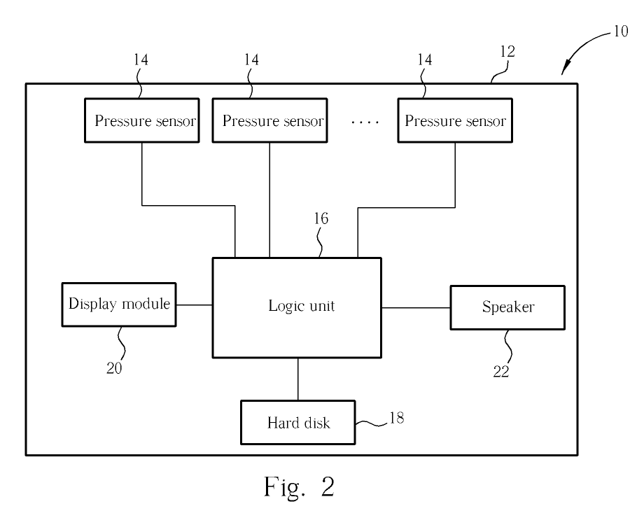

Please refer to FIG. 1 and FIG. 2. FIG. 1 is a schematic diagram of a portable electronic device 10 according to the present invention. FIG. 2 is a functional block diagram of the portable electronic device 10 according to the present invention. The portable electronic device 10 can be a mobile phone, a personal digital assistant, a notebook, an AV display device with a hard disk, and so on. The portable electronic device 10 includes a housing 12 for covering internal components. The housing 12 includes a lateral plane 12a, a lateral plane 12b, a bottom plane 12c, and a back plane 12d. The portable electronic device 10 further includes a plurality of pressure sensors 14 installed on the lateral plane 12a, the lateral plane 12b, the bottom plane 12c, and the back plane 12d of the housing 12. The portable electronic device 10 further includes a logic unit 16 for controlling operation of the portable electronic device 10, a hard disk 18 for storing data, a display module 20 for displaying processing data of the portable electronic device 10, and a speaker 22 for transforming signals transmitted from the logic unit 16 into sound waves.

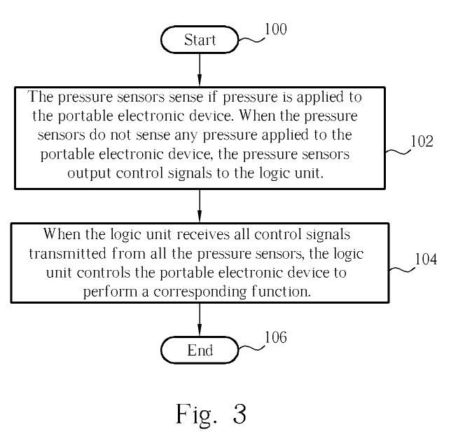

Please refer to FIG. 3. FIG. 3 is a flowchart of the portable electronic device 10 performing a function according to a sensing result of pressure according to the present invention. The method includes the following steps:

Step 100: Start.

Step 102: The pressure sensors 14 of the portable electronic device 10 sense if pressure is applied to the portable electronic device 10. When the pressure sensors 14 do not sense any pressure applied to the portable electronic device 10, the pressure sensors output control signals to the logic unit 16.

Step 104: When the logic unit 16 receives all control signals transmitted from all the pressure sensors 14, the logic unit 16 controls the portable electronic device 10 to perform a corresponding function.

Step 106: End.

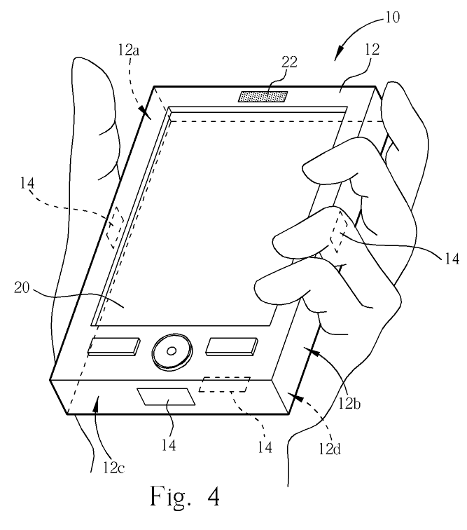

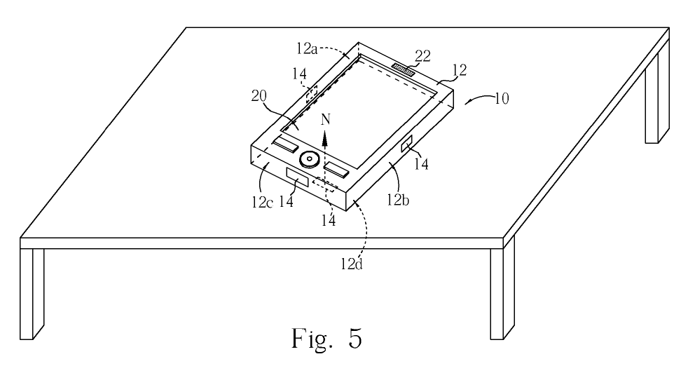

For instance, please refer to FIG. 4 and FIG. 5. FIG. 4 is a diagram of the portable electronic device 10 held by a user's hand. FIG. 5 is a diagram of the portable electronic device 10 positioned on a table. As shown in FIG. 4, when the user holds the portable electronic device 10, the pressure sensors 14 positioned on the lateral plane 12a, the lateral plane 12b, the bottom plane 12c, and the back plane 12d will sense the pressure applied by the user's hand. As shown in FIG. 5, when the portable electronic device 10 is positioned on the table, the pressure sensors 14 positioned on the back plane 12d will sense the normal pressure N applied by the table. When the portable electronic device 10 shown in FIG. 4 and FIG. 5 is in use, at least one pressure sensor 14 will sense pressure applied to the portable electronic device 10 and will not output the control signal to the logic unit 16, so that the logic unit 16 will not control the portable electronic device 10 to perform the corresponding function.

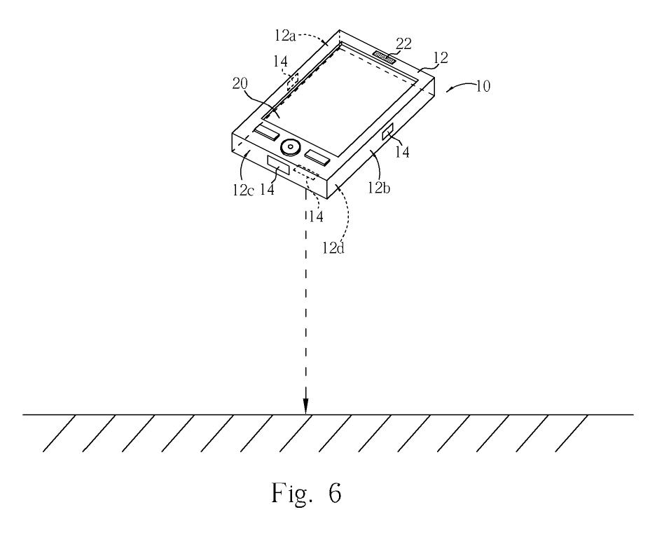

Please refer to FIG. 6. FIG. 6 is a diagram of the portable electronic device 10 when falling. As shown in FIG. 4 and FIG. 6, when the user holds the portable electronic device 10, the pressure sensors 14 positioned on the lateral plane 12a, the lateral plane 12b, the bottom plane 12c, and the back plane 12d will sense the pressure applied by the user's hand. That is, at least one pressure sensor 14 will sense pressure applied to the portable electronic device 10 and will not output the control signal to the logic unit 16, so that the logic unit 16 will not control the portable electronic device 10 to perform the corresponding function. When the portable electronic device 10 falls from the hand of the user, there is no constraint applied to the pressure sensors 14 positioned on the lateral plane 12a, the lateral plane 12b, the bottom plane 12c, and the back plane 12d, that is, there is no pressure applied to the pressure sensors 14 positioned on the lateral plane 12a, the lateral plane 12b, the bottom plane 12c, and the back plane 12d, so that the logic unit 16 will receive the control signals transmitted from all the pressure sensors 14 for controlling the portable electronic device 10 to perform the corresponding function. Additionally, the portable electronic device 10 can perform the corresponding function a predetermined duration after the logic unit 16 receives the control signals transmitted from all the pressure sensors 14. The predetermined duration can be determined according to a height that the portable electronic device 10 is permitted to fall. The greater the permitted height of the portable electronic device 10, the longer the predetermined duration.

The function performed by the portable electronic device 10 according to the command of the logic unit 16 can be an action of controlling the hard disk to park a magnetic head for preventing the magnetic head from causing damage or being damaged, an action of controlling the portable electronic device 10 to turn off for avoiding operating under an abnormal situation, an action of controlling the display module 20 to present a warning message for warning the user, or an action of controlling the speaker 22 to send out a warning sound for warning the user. The actions can serve to prevent damage to the portable electronic device 10 or the data therein.

In addition, the pressure sensor 14 of the portable electronic device 10 can output a sensing signal at periodic time intervals to the logic unit 16 when the pressure sensor 14 senses pressure applied on the portable electronic device 10 according to the present invention. If the logic unit 16 does not receive any sensing signal transmitted from the pressure sensor 14 during the time interval, it means that there is no pressure applied to the pressure sensor 14, which results in the portable electronic device 10 performing the corresponding function. The time interval can be determined according to a permitted height that the portable electronic device 10 is allowed to fall. The greater the permitted height of the portable electronic device 10, the longer the time interval.

The number and the location of the pressure sensors of the present invention can be designed according to demand. For instance, for increased accuracy of the sensing result of the pressure sensor 14, several pressure sensors 14 can be installed on the portable electronic device 10 in different positions so as to prevent an erroneous judgment due to a lack of a pressure sensor at a given location. There is a tradeoff between the accuracy and the cost of installing pressure sensors.

In contrast to the prior art, the portable electronic device and the method thereof according to the present invention can control the operation of the portable electronic device according to the sensing result of whether pressure is applied on the portable electronic device. This can prevent the portable electronic device from being damaged or undergoing a system crash, and can further lower the chance of hard disk damage or data loss.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A portable electronic device comprising:
a housing;
a pressure sensor installed on the housing for sensing pressure applied to the portable electronic device; and
a logic unit for controlling operation of the portable electronic device according to a sensing result of the pressure sensor.

2. The portable electronic device of claim 1 further comprising a hard disk installed inside the housing, wherein the logic unit controls the hard disk to park a magnetic head when the pressure sensor does not sense any pressure applied to the portable electronic device.

3. The portable electronic device of claim 1 wherein the logic unit controls the portable electronic device to turn off when the pressure sensor does not sense any pressure applied to the portable electronic device.

4. The portable electronic device of claim 1 further comprising a warning interface electrically connected to the logic unit, wherein the logic unit controls the warning interface to present a warning message when the pressure sensor does not sense any pressure applied to the portable electronic device.

5. The portable electronic device of claim 4 wherein the warning interface is a display module.

6. The portable electronic device of claim 4 wherein the warning interface is a speaker.

7. The portable electronic device of claim 1 being a personal digital assistant.

8. The portable electronic device of claim 1 being a mobile phone.

9. The portable electronic device of claim 1 being a notebook computer.

10. A method for controlling a portable electronic device according to a sensing result of pressure applied to the portable electronic device, the method comprising:
sensing whether pressure is applied to the portable electronic device; and
controlling the portable electronic device to perform a function according to the sensing result of pressure applied to the portable electronic device.

11. The method of claim 10 wherein controlling the portable electronic device to perform a function according to the sensing result of pressure applied to the portable electronic device comprises controlling a hard disk of the portable electronic device to park a magnetic head when not sensing any pressure applied to the portable electronic device.

12. The method of claim 10 wherein controlling the portable electronic device to perform a function according to the sensing result of pressure applied to the portable electronic device comprises turning off the portable electronic device when not sensing any pressure applied to the portable electronic device.

13. The method of claim 10 wherein controlling the portable electronic device to perform a function according to the sensing result of pressure applied to the portable electronic device comprises controlling the portable electronic device to present a warning message when not sensing any pressure applied to the portable electronic device.
